(19) United States
(12) Patent Application Publication
(10) Pub. No.: US 2009/0143078 A1
(43) Pub. Date: Jun. 4, 2009

(54) TECHNIQUES TO MANAGE A RADIO BASED ON LOCATION INFORMATION

(75) Inventors: Jerome C. Tu, Saratoga, CA (US); Jianxiong Shi, Pleasanton, CA (US); Janell L. Paulson, Carlsbad, CA (US); George Thomas, San Diego, CA (US); Thomas Fong, San Diego, CA (US); Gurunath Ramaswamy, San Diego, CA (US)

Correspondence Address: KACVINSKY LLC;4500 BROOKTREE ROAD, SUITE 102, WEXFORD, PA, 15090, US

(73) Assignee: PALM, INC., SUNNYVALE, CA (US)

(21) Appl. No.: 11/947,861

(22) Filed: Nov. 30, 2007

(51) Int. Cl. H04Q 7/20

(52) U.S. Cl. 455/456.3

(57) ABSTRACT

Techniques to manage a radio based on location information are described. A mobile computing device may include a radio module, a location detector operative to determine a location for the mobile computing device, and a processor to couple to the radio module and the resource database. The processor may be operative to execute a resource management module to access a resource profile having resource information for one or more cellular radiotelephone network resources accessible from the location, and control operations for a radio module based on the resource profile. Other embodiments are described and claimed.

### BACKGROUND

Mobile computing devices, such as smart phones, may provide various processing capabilities. For example, mobile devices may provide personal digital assistant (PDA) features, including word processing, spreadsheets, synchronization of information (e.g., e-mail) with a desktop computer, and so forth.

In addition, such devices may have wireless communications capabilities. More particularly, mobile devices may employ various communications technologies to provide features, such as mobile telephony, mobile e-mail access, web browsing, and content (e.g., video and radio) reception. Exemplary wireless communications technologies include cellular, satellite, and mobile data networking technologies.

Providing both processing and communications capabilities in a single device produces exceptional power management issues for smart phones, particularly as form factors for smart phones continue to decrease. For example, having a radio continuously or periodically scan for available radio channels to communicate information may consume significant amounts of power. As a result, battery life for a smart phone may be substantially shortened. This may force frequent recharging operations, thereby impairing the convenience of such devices. Consequently, improved power management techniques are desired.

### BRIEF DESCRIPTION OF THE DRAWINGS

FIG. 1 illustrates one embodiment of a communications system.

FIG. 2 illustrates one embodiment of a cellular system.

FIG. 3 illustrates one embodiment of a logic diagram.

FIG. 4 illustrates one embodiment of a mobile computing device.

### DETAILED DESCRIPTION

Various embodiments may be generally directed to techniques to manage or control a radio for a mobile computing device, such as a smart phone. Some embodiments may be particularly directed to intelligently managing or controlling a radio based on location information and a resource information map.

A mobile communication device may utilize location information and resource information map to enhance various operations for one or more elements of the mobile communication device, such as a radio module. For example, some embodiments may enhance and optimize wireless channel scanning algorithms for the radio module by selectively scanning, or avoiding, certain radio-frequencies based on the location information and resource information. This may improve radio operations for the communications portion of the mobile communications device, particularly for cellular radiotelephone networks. This may also improve power management operations for a mobile computing device, thereby extending battery life and providing an enhanced user experience.

A resource information map provides the mobile computing device a more precise and efficient way to manage operations of one or more radio modules implemented by the mobile computing device. The resource information map may represent current or previous information about the wireless environment. More particularly, the resource information map may include resource information representing various aspects of a wireless environment for longer range communications techniques or modes, such as typically found in a Wireless Wide Area Network (WWAN) system. An example of a WWAN system may include without limitation a cellular radiotelephone system or network. The resource information may represent cellular radiotelephone network equipment, capabilities and other operational details for the cellular radiotelephone network equipment, channel characteristics, geographical characteristics, and so forth. For example, the resource information may include cell site identifiers, equipment identifiers, channel identifiers, available bandwidth, communication speeds, topological map features, user attributes, and so forth. A given set of resource information may correspond or map to various locations at varying degrees of location granularity, such as within a particular cell, a set of cells, a predetermined distance, a communications pattern or envelope, and so forth. The resource information may be used to control, modify or adjust various operations for a mobile computing device, such as frequency scanning algorithms, cell selection algorithms, network selection algorithms, idle mode re-selection algorithms, and so forth.

In one embodiment, for example, a mobile computing device may include a radio module and a location detector. The location detector may be operative to determine a current location, and in some cases a predicted location, for the mobile computing device. The mobile computing device may further include a processor to couple to the radio module and the resource database. The processor may be operative to execute a resource management module to access a resource profile having resource information for one or more cellular radiotelephone network resources accessible from the current location or predicted location. The resource profile may be stored as part of a resource database implemented locally with the mobile computing device. Additionally or alternatively, the resource profile may be stored as part of a resource database implemented remotely from the mobile computing device, such as with a remote network server.

The resource management module may be arranged to control operations for a radio module based on the resource profile. For example, the resource management module may control scanning operations performed by the radio module in accordance with resource information stored by the resource profile. The resource management module may send control directives to focus, reduce, suspend or resume scanning operations when the mobile computing device is near a particular set of cellular radiotelephone network resources, as indicated by the location information and corresponding resource profile. For instance, the resource management module may send control directives to the radio module to selectively scan for specific cell sites or radio channels, rather than an entire list of cell sites or radio channels. In another example, the resource management module may send control directives to the radio module to selectively avoid certain cell sites or radio channels. Other embodiments are described and claimed.

Controlling scanning operations for a radio module of a mobile computing device based on location information and a resource information map may provide several advantages. For example, a radio module typically scans for radio signals on a continuous or periodic basis for a number of different reasons, such as to receive telephone calls, initiate telephone calls, improve call quality, perform hand-off operations, and so forth. Such scanning operations draw a significant amount of power from a power supply (e.g., a battery) for the mobile computing device. The power supply has limited amounts of power, and efficient use of the power supply provides various operational advantages. The radio module, however, typically performs the same or similar set of scanning operations regardless of whether there are any wireless resources within communication range, or without consideration to the type of wireless resources within communication range. This condition is particularly unnecessary whenever the mobile computing device is in an area with little or no wireless coverage, or is attempting to scan for cellular radiotelephone equipment that is unavailable or of the wrong type. Such generic operations may unnecessarily draw power from the power supply, thereby reducing battery life. Furthermore, this may delay the mobile computing device from acquiring a usable communication signal, leading to an undesirable user experience.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include other combinations of elements in alternate arrangements as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

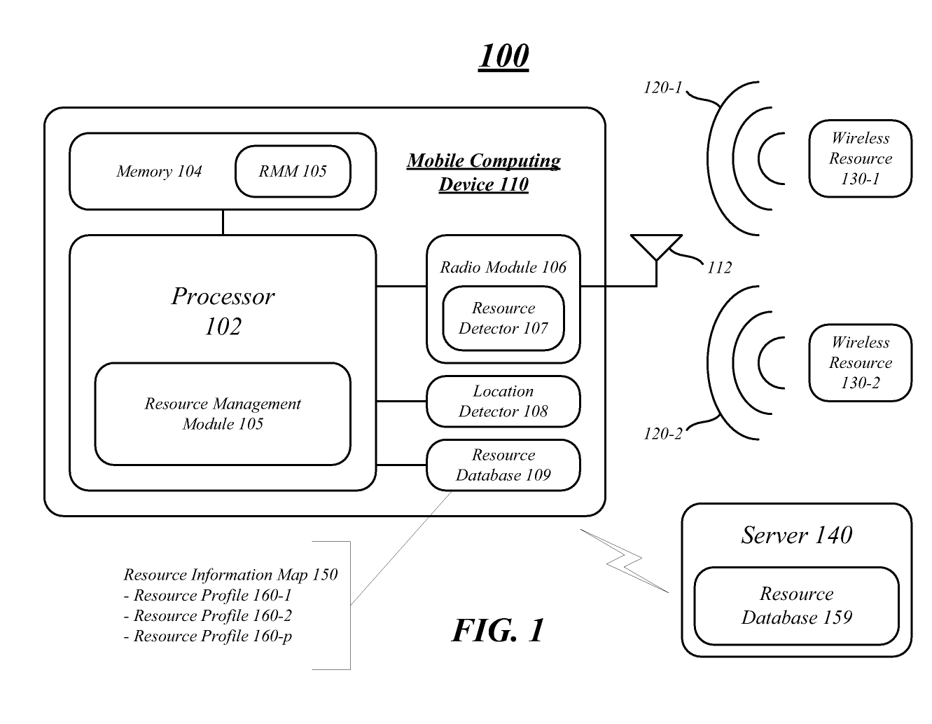

FIG. 1 illustrates one embodiment of an apparatus that may communicate across different types of wireless links. In particular, FIG. 1 shows a communications system 100 comprising various representative elements, including a mobile computing device 110 capable of communicating via radio signals 120-1-m with one or more wireless resources 130-1-n. The mobile computing device 110 may include by way of example and not limitation a processor 102, a memory 104, a resource management module 105, a radio module 106, a location detector 108, a resource database 109, and an antenna 112. The radio module 106 may further include a resource detector 107. These elements or portions of these elements may be implemented in hardware, software, firmware, or in any combination thereof. The embodiments are not limited to these depicted elements.

In some embodiments, one or more interfaces may employ various techniques to exchange information between the elements of the mobile computing device 110. For example, an interface may activate and/or detect activated signal lines. Such signal lines may be dedicated to particular signals. Alternatively, an interface may generate data messages to be transmitted across various connections. Exemplary connections may include a parallel interface, a serial interface, a bus interface, and/or a data network.

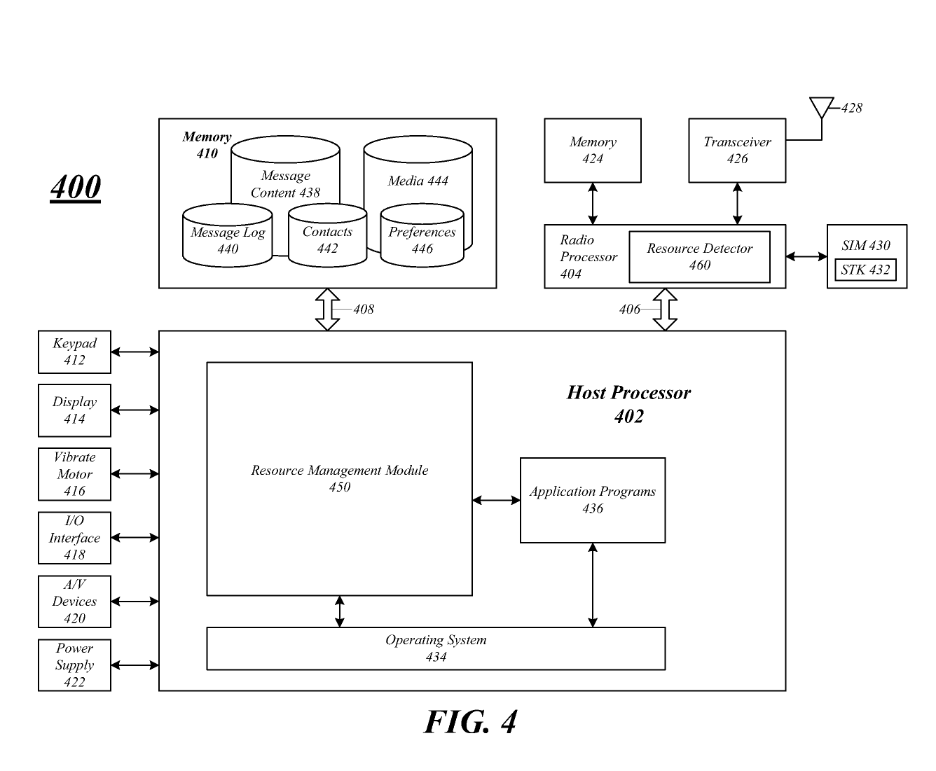

The mobile computing device 110 may be generally configured to support or provide cellular voice communication, wireless data communication and computing capabilities. The mobile computing device 110 may be implemented as a combination handheld computer and mobile telephone, sometimes referred to as a smart phone. Examples of smart phones include, for example, Palm®) products such as Palm® Treo™ smart phones. Although some embodiments may be described with the mobile computing device 110 implemented as a smart phone by way of example, it may be appreciated that the embodiments are not limited in this context. For example, the mobile computing device 110 may comprise, or be implemented as, any type of wireless device, mobile station, or portable computing device with a self-contained power source (e.g., battery) such as a laptop computer, ultra-laptop computer, personal digital assistant (PDA), cellular telephone, combination cellular telephone/PDA, mobile unit, subscriber station, user terminal, portable computer, handheld computer, palmtop computer, wearable computer, media player, pager, messaging device, data communication device, and so forth. Additional details for a mobile computing device may be described in more detail with reference to FIG. 4.

The processor 102 may comprise a general purpose processor or an application specific processor arranged to provide general or specific computing capabilities for the communications system 100. For example, the processor 102 may perform operations associated with higher layer protocols and applications. For instance, the processor 102 may be implemented as a host processor to provide various user applications, such as telephony, text messaging, e-mail, web browsing, word processing, video signal display, and so forth. In addition, the processor 102 may provide one or more functional utilities that are available to various protocols, operations, and/or applications. Examples of such utilities include operating systems, device drivers, user interface functionality, and so forth.

The memory 104 may comprise computer-readable media such as volatile or non-volatile memory units arranged to store programs and data for execution by the processor 102. As depicted in FIG. 1, the memory 104 may store a resource management module 105 in the form of executable program instructions, code or data. The processor 102 may retrieve and execute the program instructions, code or data from the memory 104 to control or provide scanning operations for the mobile computing device 110. Although the resource management module 105 is shown as part of the memory 104 for execution by the processor 102, it may be appreciated that the resource management module 105 may be stored and executed by other memory and processing resources available to the mobile computing device 110, such as a radio processor and accompanying memory implemented by the radio module 106. Further, although the resource management module 105 is depicted as software executed by a processor, it may be appreciated that the operations for the resource management module 105 may be implemented in hardware as well using one or more integrated circuits, for example. The embodiments are not limited in this context.

The radio module 106 may comprise various radio elements, including a radio processor, one or more transceivers, amplifiers, filters, switches, and so forth. The radio module 106 may communicate with remote devices across different types of wireless links utilizing various WWAN communications techniques. For example, the radio module 106 may communicate across wireless links provided by one or more cellular radiotelephone systems. Examples of cellular radiotelephone systems may include Code Division Multiple Access (CDMA) systems, GSM systems, North American Digital Cellular (NADC) systems, Time Division Multiple Access (TDMA) systems, Extended-TDMA (E-TDMA) systems, Narrowband Advanced Mobile Phone Service (NAMPS) systems, third generation (3G) systems such as Wide-band CDMA (WCDMA), CDMA-2000, Universal Mobile Telephone System (UMTS) systems, and so forth. The radio module 106 (or a second radio module) may also communicate across data networking links provided by one or more cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and so forth. The embodiments, however, are not limited to these examples.

In some cases, the radio module 106 may additionally or alternatively communicate across various non-cellular communications links. The radio module 106 may be arranged to provide voice and/or data communications functionality in accordance with different types of wireless network systems or protocols. Examples of suitable wireless network systems offering data communication services may include the Institute of Electrical and Electronics Engineers (IEEE) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, and so forth. The mobile computing device 400 may also utilize different types of shorter range wireless systems, such as a Bluetooth system operating in accordance with the Bluetooth Special Interest Group (SIG) series of protocols, including Bluetooth Specification versions v1.0, v1.1, v1.2, v1.0, v2.0 with Enhanced Data Rate (EDR), as well as one or more Bluetooth Profiles, and so forth. Other examples may include systems using infrared techniques or near-field communication techniques and protocols, such as electro-magnetic induction (EMI) techniques. An example of EMI techniques may include passive or active radio-frequency identification (RFID) protocols and devices.

It may be appreciated that the radio module 106 may utilize different communications elements (e.g., radio processors, transceivers, etc.) to implement different communications techniques. Furthermore, the radio module 106 may support multiple communications techniques by implementing multiple sets of corresponding radio equipment. For example, the radio module 106 may support GSM communications using a first transceiver, IEEE 802.xx (e.g., 802.11) communications using a second transceiver, Bluetooth communications using a third transceiver, and so forth. The embodiments are not limited in this context.

The radio module 106 may be arranged to periodically or continuously scan wireless shared media, such as one or more portions of the radio-frequency (RF) spectrum, for the various radios implemented by the radio module 106. The radio module 106 may implement a scanning algorithm to perform various scanning operations for radio energy. Radio energy may refer to RF energy used by a radio or wireless transceiver for communicating information, rather than spurious energy received from various electronic devices, such as a microwave, monitor, television, and so forth. For example, the radio module 106 may measure a received radio signal strength, received signal strength (RSS) or received signal strength indication (RSSI) from nearby wireless resources (collectively referred to herein as “RSSI”). An RSSI is typically a measurement of the power present in a received radio signal in arbitrary units. The RSSI may provide an indication of how much information may be communicated between devices. Typically a lower RSSI implies lower information rates or quality, while a higher RSSI implies higher information rates or quality.

The scanning operations may include scanning for radio energy of a given RSSI in the appropriate bands or sub-bands of the RF spectrum allocated to the one or more transceivers or radios implemented by the radio module 106. For example, the radio module 106 may scan for various radio signals 120-1-m received from various wireless resources 130-1-n. The wireless resources 130-1-n may utilize a radio module implementing the same or similar communication techniques as implemented for the radio module 106. The radio module 106 may perform the scanning operations using a scan list to scan various sets of frequencies. The radio module 106 may perform scanning operations for any number of reasons, such as establishing, managing or terminating a voice communication session or a data communication session, performing hand-off operations when the mobile computing device 110 is moving between wireless resources (e.g., 130-1, 130-2), switching communication channels for the same wireless resource (e.g., 130-1) due to bandwidth or quality issues, and so forth.

The location detector 108 may be arranged to detect a location for the mobile computing device 110. The location detector 108 may comprise or be implemented using any particular location detection device or technique, such as an accelerometer, a gyroscope, a global positioning system, a network enhanced global positioning system, a base station proximity system, a triangulation system, a time difference system, a camera, a proximity sensor, and so forth. The location detector 108 may be suitable for use with different map systems, such as a navigation system for a vehicle. The location detector 108 may determine a current position for the mobile computing device 110, and in some cases, a predicted position for the mobile computing device 110 based on velocity and direction information.

In general operation, the mobile computing device 110 may provide various communications and computing resources for an operator or user. For example, the radio module 106 may be operative to continuously or periodically scan for radio signals from one or more wireless resources, such as the radio signals 120-1, 120-2 from the respective wireless resources 130-1, 130-2. The radio module 106 may perform such scanning operations in anticipation of the mobile computing device 110 initiating or receiving a voice communication (e.g., telephone call) or a data communication (e.g., text message, instant message). The radio module 106 may perform such scanning operations during a voice communication or data communication session as well, such as when anticipating a hand-off between different sets of cellular radiotelephone infrastructure equipment (e.g., base stations).

In some cases, the mobile computing device 110 may not have access to any wireless resources. This may occur whenever the mobile computing device is outside the effective communication range of the wireless resources 130-1-n. In one embodiment, the radio module 106 may be operative to detect when radio energy for one or more of the radio signals 120-1-m as transmitted from the wireless resources 130-1-n are below a certain threshold. For example, the radio module 106 may measure a RSSI from nearby wireless resources. When the RSSI is below a certain value, the mobile computing device 110 may experience reduced communication capabilities, and in some cases, may be unable to communicate any information with the wireless resources 130-1-n. The latter case may sometimes be referred to as a “lost coverage” or a “no coverage” condition.

The radio module 106 continuously monitors the radio environment by scanning for wireless resources 130-1-n that may be within range of the mobile computing device 110. The radio module 106 may continuously scan various operating frequencies for the various transceivers implemented for the radio module 106 randomly or using a scan list. Such unfocused scanning operations may consume significant amounts of power from the power supply that has finite energy. This problem may be exacerbated whenever the mobile computing device 110 is in an area with weak coverage or no coverage, or located at a common boundary edge for two or more wireless resources 130-1-n. In the latter case, the radio module 106 may cycle through channel measurements for all the wireless resources 130-1-n within communication range of the radio module 106, such as when attempting to determine whether a wireless resource has a stronger signal in anticipation of performing hand-off operations. Such scanning activity may cause the mobile computing device 110 to drain the battery.

To solve these and other problems, the resource management module 105 may control activities for one or more elements of the mobile computing device 110. This may involve sending one or more directives to the appropriate elements. To provide such control, the resource management module 105 may include various logic, routines and/or circuitry that operate on information received from other elements. In one embodiment, for example, the resource management module 105 may control operations of the radio module 106 based on inputs received from the location detector 108 and the resource information stored by the resource database 109 and/or the resource database 159. The resource management module 105 may output various control directives to the radio module 106 to control various operations of the mobile computing device 110, such as scanning operations for the radio module 106, based on the received inputs. In embodiments, one or more processors may execute such logic and routines.

In one embodiment, the processor 102 may be arranged to execute the resource management module 105. The resource management module 105 may be operative to access a resource information map 150 having one or more resource profiles 160-1-p. The resource management module 105 may access the resource information map 150 as stored by the resource database 109 of the mobile computing device 110. Additionally or alternatively, the resource management module 105 may access the resource information map 150 as stored by the resource database 159 of the server 140.

As previously described, the resource information map 150 may represent current or previous information about the wireless environment of the communications system 100. More particularly, the resource information map 150 may be particularly focused to include resource information representing various aspects of a wireless environment for longer range communications techniques or modes, such as a cellular radiotelephone system or other WWAN system. For example, the resource information may represent cellular radiotelephone network equipment, capabilities and other operational details for the cellular radiotelephone network equipment, channel characteristics, geographical characteristics, and so forth. The resource information may be stored as part of a resource profile 160-1-p, with each resource profile 160-1-p representing a defined geographic location.

Each resource profile 160-1-p may include resource information for one or more wireless resources 130-1-n. In one embodiment, the wireless resources 130-1-n may comprise or represent cellular radiotelephone network equipment or resources. For example, the cellular radiotelephone network equipment or resources may comprise or represent cellular radiotelephone network infrastructure equipment, such as a base station, a base station sub-system (BSS), a base transceiver station (BTS), a base station controller (BSC), a node B, a network sub-system (NSS), a mobile subscriber center (MSC), and so forth. The cellular radiotelephone network equipment or resources may be part of any desired cellular radiotelephone system as previously described. For example, the cellular radiotelephone network equipment may be compatible with a Time Division Multiple Access (TDMA) or Code Division Multiple Access (CDMA) based system.

The resource information may include any type of information associated with a wireless resource 130-1-n. For example, the resource information may comprise information about a wireless resource that is useful in evaluating how to optimize or improve communications between the mobile computing device 110 and the wireless resource 130-1-n. Examples of resource information may include without limitation a wireless station (e.g., a base station or Node B), capabilities information for a wireless station (e.g., GSM, GPRS, voice services, data services, message services, etc.), identification information for a wireless station (e.g., a cell site identifier, a base station identifier, a device identifier, a network identifier, equipment identifier, etc.), location information for a wireless station (e.g., longitude coordinates, latitude coordinates, altitude or elevation, GPS coordinates, etc.), location determination technique (e.g., GPS, triangulation, etc.), object oriented data description for a wireless station, a timestamp for last detection or visit to a wireless station, user annotations (e.g., known dead spot), keywords for a wireless station, location boundaries, cell site boundaries, and other attributes for a wireless station. The specific type of resource information may vary according to a particular cellular radiotelephone system supported by the mobile computing device 110. The embodiments are not limited in this context.

More particularly, each resource profile 160-1-p may include resource information for one or more wireless resources 130-1-n accessible from a given location for the mobile computing device 110. The location of a wireless resource 130-1-n is an important part of the resource databases 109, 159. One important issue is the resolution of measurements in the system, and the location determination. If the resolution is too fine grain, the resource databases 109, 159 may become too large, and the coverage areas disjoint. If the resolution is too coarse, the results may be ambiguous and not useful. Accordingly, some factors that may be considered in developing the location resolution for a system may include location accuracy, variance in signal strengths (or coverage areas) of mobile devices, characteristics of the physical environment, and so forth.

There may be multiple ways in which the location information may be stored. For example, the resource databases 109, 159 may be arranged to store all recorded measurements. This is the simplest solution, but is not practical for reasons of memory requirements, and slow/complex searching algorithms. In another example, the resource databases 109, 159 may be arranged to store estimated locations for wireless resources 130-1-n and accompanying radius of coverage. In yet another example, the resource databases 109, 159 may store actual or estimated boundaries of coverage area. This allows for non-symmetrical radiation patterns to be considered which may be significant for many environments, although it may require more complex searching algorithms. In still another example, the resource databases 109, 159 may store polygons or other cell site shapes. The polygon represents a non-circular (or spherical) coverage area. The shape of the polygon is determined by analysis of multiple measurements. In one embodiment, for example, the location granularity may approximate cell sites for a cellular radiotelephone system. The embodiments, however, are not limited in this context.

The resource information map 150 may be created or generated using information collected by the mobile computing device 110. In one embodiment, the radio module 106 may include a resource detector 107 operative to collect resource information for a given location. As the mobile computing device 110 travels across various locations, the resource detector 107 may collect various types of resource information for the various locations, thereby systematically building the resource information map 150. The resource management module 105 may receive the resource information from the resource detector 107, receive location information from the location detector 108, create a resource profile 160-1-p with the resource information and the location information, and store the resource profile 160-1-p in the resource database 109. Additionally or alternatively, the resource management module 105 may create the resource profile 160-1-p, and send the resource profile 160-1-p to the server 140.

The server 140 may include a resource database 159 similar to the resource database 109. By way of contrast to the resource database 109, however, the resource database 159 may receive various resource profiles 160-1-p from the mobile computing device 110, as well as other mobile computing devices. In this manner, the resource database 159 may be systematically built with information from multiple mobile computing devices over time. This may lead to a more robust and comprehensive resource information map 150. The mobile computing device 110, and other mobile computing devices, may then access the resource database 159 from the server 140 on a periodic basis to synchronize the resource databases 109, 159. This may be accomplished on a “pull” basis, where the resource management module 105 is programmed to periodically request data from the server 140 to synchronize the resource databases 109, 159. This may also be accomplished on a “push” basis, where the server 140 is programmed to periodically push data from the server 140 to the mobile computing device 110 to perform the desired synchronization. For those devices with insufficient memory resources to store the entire resource databases 109, 159, a mobile computing device may access the resource database 159 to use or consume portions of the resource database 159 when needed.

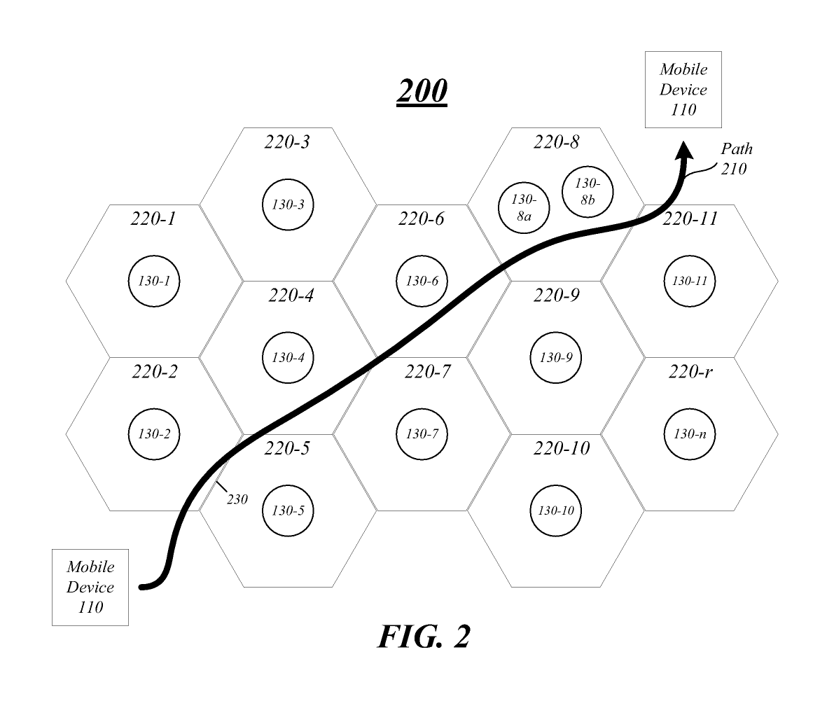

FIG. 2 illustrates one embodiment of a cellular system 200. The cellular system 200 may comprise an exemplary cellular radiotelephone system suitable for use with some embodiments. The cellular system 200 may comprise multiple cell sites 220-1-r each providing wireless services for a geographic area represented by a hexagon. Each cell site 220-1-r may be serviced by one or more wireless resources 130-1-n. For example, the wireless resources 130-1-n may each comprise cellular radiotelephone base stations. Assume the mobile device 110 traverses various cell sites 220-1-r of the cellular system 200 as it travels along path 210. As shown in FIG. 2, the mobile computing device 110 may traverse portions of cell sites 220-2, 220-4, 220-5, 220-6 and 220-8 along path 210.

Further assume the location granularity is selected as a cell site in the cellular system 200. The resource detector 107 may collect resource information for all wireless resources 130-1-n within, or accessible from, a given cell site. This may include wireless resources for a current cell site or a neighbor cell site accessible from the location. For example, as the mobile computing device 110 enters communication range for cell site 220-2, the resource detector 107 may begin detecting communications signals from the wireless resource 130-2. Because the transmission pattern for the wireless resources 130-1-n are typically not identical to the hexagonal representations for the cell sites 220-1-r, the resource detector 107 may also detect overlapping communication signals from neighboring cell sites, such as from the wireless resources 130-4, 130-5 from the respective cell sites 220-4, 220-5. This may be particularly true as the mobile computing device 110 approaches a boundary area as represented by boundary 230 between the cell sites 220-2, 220-5.

As the mobile device 110 traverses a particular cell site along path 210, the radio detector 107 may perform periodic or continuous measurements of the wireless RF environment to collect resource information for each cell site 220-1-r. For example, the resource detector 107 may collect resource information such as a cell site identifier, a RSSI value, and a RF channel identifier for each cell site, and output the resource information to the resource management module 105. The resource management module 105 may receive location information for the mobile computing device 110, correlate the location information with a given cell site, and generate a resource profile 160-1-p with the resource information and cell site. For example, the resource management module 105 may collect resource information while located within the cell site 220-2, receive location information indicating that the mobile computing device 110 is actually located within the cell site 220-2, and create a resource profile 160-2 with the resource information collected within the cell site 220-2 and the actual (e.g., precise GPS coordinates) or approximate location (e.g., cell site coordinates) of the mobile computing device 110 when collecting the resource information. The resource management module 105 may store the resource profile 160-2 in the local resource database 109 or the remote resource database 159, as optionally indexed by the cell site 220-2 to facilitate search operations on the resource databases 109, 159.

The resource management module 105 may control various operations for various elements of the mobile computing device 110. In one embodiment, the resource management module 105 may control various operations for the radio module 106 based on a resource profile 160-1-p for a given location. In one embodiment, the resource management module 105 may be operative to send one or more control directives to the radio module 106 to control scanning operations for radio signals by the radio module 106 in accordance with resource information stored by a resource profile 160-1-p. For example, the resource management module 105 may be operative to send a control directive to the radio module 106 to selectively scan for a RF channel or set of RF channels for a cell site based on RF channel identifiers and cell site identifiers stored by a resource profile 160-1-p. In another example, the resource management module 105 may be operative to send a control directive to the radio module 106 to selectively avoid a RF channel or set of RF channels for a cell site based on RF channel identifiers and cell site identifiers stored by a resource profile 160-1-p.

Continuing with our previous example, assume the mobile device 110 travels along the same or similar path 210 sometime after the resource profile 160-2 was created, whether by the resource management module 105 of the mobile computing device 110, or some other mobile computing device (accessible via the resource database 159). When entering the cell site 220-2, the resource management module 105 may receive location information from the location detector 108 indicating that the current location for the mobile computing device 110 is within the boundaries of the cell site 220-2. The resource management module 105 may search the resource database 109 and/or the resource database 159 for the resource profile 160-2 from the resource information map 150 using the location information for the cell site 220-2. The resource management module 105 may access the resource profile 160-2 corresponding to the cell site 220-2, and retrieve the resource information stored by the resource profile 160-2. Assume the resource information for the resource profile 160-2 includes a first RF channel for the wireless resource 130-2 of the current cell site 220-2, and a second RF channel for the wireless resource 130-5 of the neighbor cell site 220-5. The resource management module 105 may send a control directive to the radio module 106 to selectively scan for the first RF channel and the second RF channel, rather than scanning for the entire list of RF channels normally on a scan list for the radio module 106.

In one embodiment, the resource management module 105 may be operative to send a control directive to the radio module 106 to suspend scanning operations by the radio module 106 when resource information for a given resource profile 160-1-p indicates there are no cellular radiotelephone network resources accessible from a location. For example, assume that the mobile device 110 travels along path 210 to an area outside of the coverage area for the cellular system 200. The resource management module 105 may access one or more resource profiles 160-1-p indicating that there are no cellular radiotelephone network resources available for the current location (and predicted locations) as indicated by the location detector 108. In this case, the resource management module 105 may send control instructions to the radio module 106 to suspend scanning operations to conserve power. Optionally, the resource management module 106 may send control instructions to the radio module 106 to suspend scanning operations for a defined period of time as a safety measure to ensure the radio module 106 eventually resumes scanning operations. This may be desirable, for example, when the mobile computing device 110 enters an area not represented by the resource information map 150, or if the location detector 108 becomes inoperative or disabled.

In one embodiment, the resource management module 105 may be operative to send a control directive to the radio module 106 to resume scanning operations by the radio module 106 when the resource information indicates there are cellular radiotelephone network resources accessible from the location. Once the radio module 106 has been placed in a suspended mode, the resource management module 105 may continue to receive location information from the location detector 108, and access various resource profiles 160-1-p corresponding to the location information. Once the resource information for a resource profile 160-1-p indicates the presence of wireless resources, the resource management module 105 may send control instructions to the radio module 106 to resume scanning operations in accordance with the new resource information.

In addition to suspending and resuming scanning operations, the resource management module 105 may issue a control directive to reduce a scan rate used by the radio module 106 for the scanning operations. This may reduce power consumption from the power supply for the mobile computing device 110. The scan rate may represent how often the radio module 106 scans for the radio signals 120-1-m within a given time period. For example, the radio module 106 may normally wake up from idle mode to active mode every 1 minute, perform scanning operations for 30 seconds, and revert to idle mode once scanning operations are completed without detecting any radio signals. The resource management module 105 may issue a control directive to reduce a scan rate and/or scan interval for the radio module 106, such as from 30 seconds out of every 1 minute to 30 seconds out of every 2 minutes, for example.

In one embodiment, the resource management module 105 may be operative to send a control directive to the radio module 106 to selectively avoid a RF channel or set of RF channels for a cell site based on RF channel identifiers and cell site identifiers stored by a resource profile 160-1-p. This type of directed avoidance control directive from the resource management module 105 might be useful in a case where historical data has indicated that a particular RF channel or cell site is troublesome for the mobile computing device 110, or other wireless devices.

In one embodiment, the resource management module 105 may be operative to send a control directive to the radio module 106 to focus scanning operations by the radio module 106 when resource information for a given resource profile 160-1-p indicates there are particular cellular radiotelephone network resources accessible from a given location. For example, the resource information may indicate that one or more communications channels are particularly strong for a given cell site at a certain location. The resource management module 105 may instruct the radio module 106 to focus scanning operations on the particularly identified communications channels. In another example, if the resource information indicates that the mobile computing device 110 is located within a cell site having a particularly strong signal, and the cell site also receives strong signals from neighbor cell sites, the resource management module 105 may instruct the radio module 106 to reduce or scale back on the frequency used to search for an alternative radio channel to acquire. This focuses the radio module 106 on the serving cell site, and avoids wasting energy on searching for radio signals from neighbor cell sites.

Such selectively focused control directives may be modified based on a proximate distance between the serving cell site base station and the mobile computing device 110. For example, scanning operations for the radio module 106 may be reduced as the mobile computing device 110 moves closer to the base station for the serving cell site, and increased as the mobile computing device moves away from the base station for the serving cell site.

Such selectively focused control directives may also be modified based on whether the mobile computing device 110 is mobile or stationary, as indicated by the location detector 108. For example, if the radio module 106 has a particularly strong signal from the serving cell site, and the location detector 108 indicates that the mobile computing device 110 is moving slowly or is stationary, the resource management module 106 may instruct the radio module to reduce or suspend scanning operations for other communications channels within the serving cell site and/or neighbor cell sites.

In some cases, the mobile computing device 110 may find itself within a serving cell site with multiple wireless resources representing different types of technologies or communications techniques. For example, assume the mobile computing device 110 travels along path 210 and enters the cell site 220-8. Further assume the cell site 220-8 supports multiple cellular radiotelephone networks, as represented by the wireless resources 130-8a, 130-8b. The wireless resources 130-8a, 130-8b may comprise base stations for a second generation (2G) cellular system and a third generation (3G) cellular system, respectively. The radio module 106 may have a default preference to use the 3G network. The resource information stored by the resource profile 160-8, however, may indicate that the communications channels for the 3G network are spotty and weak, while the communications channels for the 2G network are stronger. The resource management module 105 may have logic to intelligently decide when to switch to 2G and when to stay in 3G based on the resource information map 150. This would allow better service continuity and user experience.

In one embodiment, the location detector 108 may be operative to determine a location for the mobile computing device as a current location based on location information for the mobile computing device 110. In this case, the location detector 108 simply calculates and outputs a current location for the mobile computing device 110. The resource management module 105 may operate in a reactive mode and retrieve a resource profile 160-1-p associated with the current location.

In one embodiment, the location detector 108 may be operative to determine a location for the mobile computing device 110 as a predicted location based on velocity information and direction information for the mobile computing device 110. Velocity is a vector quantity with dimensions of speed and direction. Velocity is defined as the rate of change of position. It is a vector physical quantity, and therefore both speed and direction are required to define it. Speed is a scalar quantity with dimensions of distance and time. Speed is the rate of motion, or equivalently the rate of change in position, many times expressed as distance d traveled per unit of time t. By calculating a velocity for the mobile computing device 110 using speed and direction for the mobile computing device, or a relative velocity as compared to a fixed location (e.g., a wireless resource 130-1-n), the location detector 108 may implement a more complex algorithm to calculate and output one or more predicted locations for the mobile computing device 110. This may be accomplished, for example, in conjunction with various electronic maps and/or navigation techniques. In this manner, the resource management module 105 may operate in a proactive mode and retrieve a resource profile 160-1-p associated with the predicted locations. As a result, the resource management module 105 may have additional time to control the radio module 106, or other portions of the mobile computing device 110, thereby enhancing the ability of the radio module 106 to acquire an active communications channel.

In one embodiment, the location detector 108 (or the resource management module 105) may determine a current location for the mobile computing device 110. The location detector 108 may also determine a velocity and a direction for the mobile computing device 110. The location detector 108 may generate a predicted location for the mobile computing device 110 based on the velocity, the direction and the current location. The resource management module 105 may access a resource profile 160-1-p having resource information for one or more cellular radiotelephone network resources accessible from the predicted location.

In one embodiment, the mobile computing device 110 may display a message for an operator of the mobile computing device based on resource information from a resource profile 160-1-p corresponding to a predicted location for the mobile computing device 110. When using the predicted location feature, the resource management module 105 may be operative to send a control directive to an operating system (OS), alarm system, or other user interface or graphics user interface (GUI) with messages regarding potential system anomalies. For example, assume the location detector 108 determines that the mobile computing device 110 is currently located within the cell site 220-4, and at the present velocity and direction, predicts that the mobile computing device 110 will be entering cell site 220-6 of the cellular system 200 as it travels along the path 210. The resource management module 105 may retrieve a resource profile 160-6 associated with the cell site 220-6, and determine from the resource information contained within the resource profile 160-6 that the cell site 220-6 presents a “weak coverage” or “no coverage” area for the radio module 106 of the mobile computing device 110. The resource management module 105 may send a control directive to the OS or alarm manager to display a user message on a display (e.g., display 414) indicating that the mobile computing device 110 will soon be entering an area of “weak coverage” or “no coverage.” In some cases, the resource management module 105 and/or the location detector 108 may generate a predicted time value representing an amount of estimated time before entering the predicted location (e.g., “5 minutes”). In this manner, a user may be forewarned that communications with the mobile computing device 110 may be impaired or lost, thereby allowing the user to take appropriate remedial measures, such as changing driving direction, driving speed, placing a call before the predicted time interval expires, and so forth.

When using the predicted location feature, the resource management module 105 may be operative to send a control directive to the radio module 106 to switch from a first communication channel to a second communication channel based on a resource profile corresponding to a predicted location for the mobile computing device 110. For example, assume the radio module 106 of the mobile computing device 110 is currently managing a communication session over a first communication channel established between the radio module 106 and a base station for the cell site 220-4. Further assume the location detector 108 determines that the mobile computing device 110 is currently located within the cell site 220-4, and at the present velocity and direction, predicts that the mobile computing device 110 will be entering cell site 220-6 of the cellular system 200 as it travels along the path 210. The resource management module 105 may retrieve a resource profile 160-6 associated with the cell site 220-6, and determine from the resource information contained within the resource profile 160-6 that the cell site 220-6 presents a “weak coverage” or “no coverage” area for the first communication channel, but provides a stronger signal for a second communication channel. The resource management module 105 may send a control directive to radio module 106 to switch from the first communication channel to the second communication channel to reduce the possibility of dropping the call when entering the cell site 220-6. This may be accomplished while the mobile computing device 110 is still within communications range of the cell site 220-4, after the mobile computing device 110 enters communications range of the cell site 220-6, or sometime during the transition between cell sites 220-4, 220-6.

Operations for the above embodiments may be further described with reference to the following figures and accompanying examples. Some of the figures may include a logic diagram. Although such figures presented herein may include a particular logic diagram, it can be appreciated that the logic diagram merely provides an example of how the general functionality as described herein can be implemented. Further, the given logic diagram does not necessarily have to be executed in the order presented, unless otherwise indicated. In addition, the given logic diagram may be implemented by a hardware element, a software element executed by a processor, or any combination thereof. The embodiments are not limited in this context.

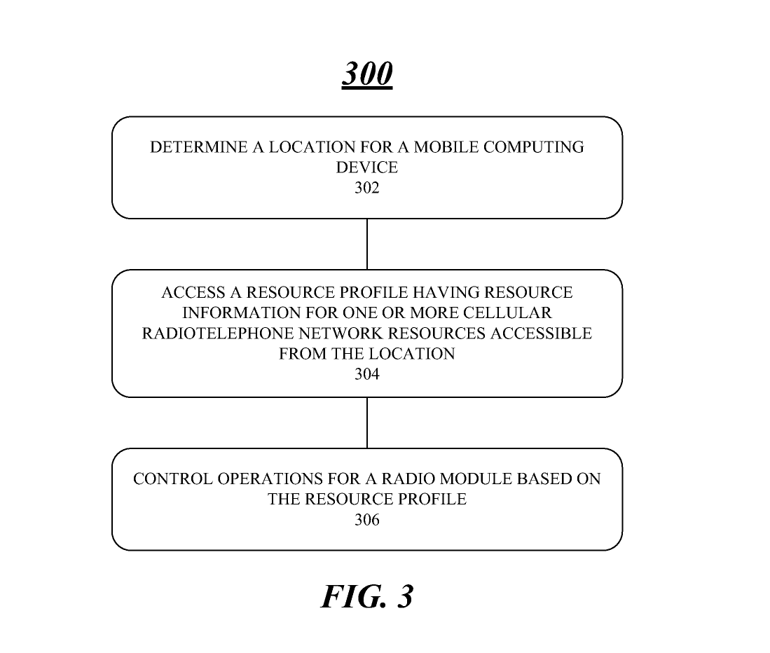

FIG. 3 illustrates one embodiment of a logic diagram. In particular, FIG. 3 illustrates a logic diagram 300, which may be representative of the operations executed by one or more embodiments described herein. As shown in the FIG. 3, the logic diagram 300 may determine a location for a mobile computing device at block 302. The logic diagram 300 may access a resource profile having resource information for one or more cellular radiotelephone network resources accessible from the location at block 304. The logic diagram 300 may control operations for a radio module based on the resource profile at block 306. The embodiments are not limited in this context.

In one embodiment, the logic diagram 300 may determine a location for a mobile computing device at block 302. For example, the location detector 108 may determine a location for the mobile computing device 110. This may occur on a continuous, on demand or periodic basis, as desired for a given implementation.

In one embodiment, the logic diagram 300 may access a resource profile having resource information for one or more cellular radiotelephone network resources accessible from the location at block 304. For example, the resource management module 105 may access a resource profile 160-1-p having resource information for one or more wireless resources 130-1-n accessible from the location of the mobile computing device 110.

In one embodiment, the logic diagram 300 may control operations for a radio module based on the resource profile at block 306. For example, the resource management module 105 may send one or more control directives to the radio module 106 to selectively perform scanning operations, reduce scanning operations, suspend scanning operations, resume scanning operations, and so forth. The particular control directive may vary in accordance with the type of resource information and the desired level of power management.

In addition to controlling scanning operations for the radio module 106 based on location information and the resource information map 150, other elements of the mobile computing device 110 may be controlled based on such information. Additional logic may be implemented to switch other elements of the mobile computing device 110 between various power modes based on the resource information. For example, the mobile computing device 110 may suspend or resume certain application processing operations when the resource information indicates the presence or absence of wireless resources 130-1-n providing data communications services. In another example, the mobile computing device 110 may select a different cell site or network from the default or user selected parameters based on the resource information for a given location. In yet another example, the mobile computing device 110 may modify when the radio module 106 enters or exits idle mode based on resource information for a given location. In still another example, the mobile computing device 110 may modify power output or antenna configurations based on the resource information. The embodiments are not limited in this context.

FIG. 4 illustrates a block diagram of a mobile computing device 400 suitable for implementing various embodiments, including the mobile computing device 110. It may be appreciated that the mobile computing device 400 is only one example of a suitable mobile computing environment and is not intended to suggest any limitation as to the scope of use or functionality of the embodiments. Neither should the mobile computing device 400 be interpreted as having any dependency or requirement relating to any one or combination of components illustrated in the exemplary mobile computing device 400.

The host processor 402 (e.g., similar to the processor 102) may be responsible for executing various software programs such as system programs and applications programs to provide computing and processing operations for the mobile computing device 400. The radio processor 404 (e.g., similar to the radio processor 124) may be responsible for performing various voice and data communications operations for the mobile computing device 400 such as transmitting and receiving voice and data information over one or more wireless communications channels. Although the mobile computing device 400 is shown with a dual-processor architecture, it may be appreciated that the mobile computing device 400 may use any suitable processor architecture and/or any suitable number of processors in accordance with the described embodiments. In one embodiment, for example, the processors 402, 404 may be implemented using a single integrated processor.

The host processor 402 may be implemented as a host central processing unit (CPU) using any suitable processor or logic device, such as a as a general purpose processor. The host processor 402 may also be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

As shown, the host processor 402 may be coupled through a memory bus 408 to a memory 410. The memory bus 408 may comprise any suitable interface and/or bus architecture for allowing the host processor 402 to access the memory 410. Although the memory 410 may be shown as being separate from the host processor 402 for purposes of illustration, it is worthy to note that in various embodiments some portion or the entire memory 410 may be included on the same integrated circuit as the host processor 402. Alternatively, some portion or the entire memory 410 may be disposed on an integrated circuit or other medium (e.g., hard disk drive) external to the integrated circuit of the host processor 402. In various embodiments, the mobile computing device 400 may comprise an expansion slot to support a multimedia and/or memory card, for example.

The memory 410 may be implemented using any computer-readable media capable of storing data such as volatile or non-volatile memory, removable or non-removable memory, erasable or non-erasable memory, writeable or re-writeable memory, and so forth. Examples of computer-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The mobile computing device 400 may comprise an alphanumeric keypad 412 coupled to the host processor 402. The keypad 412 may comprise, for example, a QWERTY key layout and an integrated number dial pad. The mobile computing device 400 also may comprise various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, and so forth. The keypad 412 may comprise a physical keypad using hard buttons, or a virtual keypad using soft buttons displayed on a display 414.

The mobile computing device 400 may comprise a display 414 coupled to the host processor 402. The display 414 may comprise any suitable visual interface for displaying content to a user of the mobile computing device 400. In one embodiment, for example, the display 414 may be implemented by a liquid crystal display (LCD) such as a touch-sensitive color (e.g., 46-bit color) thin-film transistor (TFT) LCD screen. The touch-sensitive LCD may be used with a stylus and/or a handwriting recognizer program.

The mobile computing device 400 may comprise a vibrate motor 416 coupled to the host processor 402. The vibrate motor 416 may be enable or disabled according to the preferences of the user of the mobile computing device 400. When enabled, the vibrate motor 416 may cause the mobile computing device 400 to move or shake in a generic and/or patterned fashion in response to a triggering event such as the receipt of a telephone call, text message, an alarm condition, a game condition, and so forth. Vibration may occur for a fixed duration and/or periodically according to a pulse.

The mobile computing device 400 may comprise an input/output (I/O) interface 418 coupled to the host processor 402. The I/O interface 418 may comprise one or more I/O devices such as a serial connection port, an infrared port, integrated Bluetooth wireless capability, and/or integrated 802.11x (WiFi) wireless capability, to enable wired (e.g., USB cable) and/or wireless connection to a local computer system, such as a local personal computer (PC). In various implementations, mobile computing device 400 may be arranged to synchronize information with a local computer system.

The host processor 402 may be coupled to various audio/video (A/V) devices 420 that support A/V capability of the mobile computing device 400. Examples of A/V devices 420 may include, for example, a microphone, one or more speakers, an audio port to connect an audio headset, an audio coder/decoder (codec), an audio player, a Musical Instrument Digital Interface (MIDI) device, a digital camera, a video camera, a video codec, a video player, and so forth.

The host processor 402 may be coupled to a power supply 422 arranged to supply and manage power to the elements of the mobile computing device 400. In various embodiments, the power supply 422 may be implemented by a rechargeable battery, such as a removable and rechargeable lithium ion battery to provide direct current (DC) power, and/or an alternating current (AC) adapter to draw power from a standard AC main power supply.

The radio processor 404 may be arranged to communicate voice information and/or data information over one or more assigned frequency bands of a wireless communication channel. The radio processor 404 may be implemented as a communications processor using any suitable processor or logic device, such as a modem processor or baseband processor. The radio processor 404 may also be implemented as a digital signal processor (DSP), media access control (MAC) processor, or any other type of communications processor in accordance with the described embodiments. The radio processor 404 may perform analog and/or digital baseband operations for the mobile computing device 400. For example, the radio processor 404 may perform digital-to-analog conversion (DAC), analog-to-digital conversion (ADC), modulation, demodulation, encoding, decoding, encryption, decryption, and so forth. The radio processor 404 may include a detector 460. The detector 460 may the same or similar to the detector 126 described with reference to FIG. 1.

The mobile computing device 400 may comprise a memory 424 coupled to the radio processor 404. The memory 424 may be implemented using any of the computer-readable media described with reference to the memory 410. The memory 424 may be typically implemented as flash memory and secure digital (SD) RAM. Although the memory 424 may be shown as being separate from the radio processor 404, some or all of the memory 424 may be included on the same IC as the radio processor 404.

The mobile computing device 400 may comprise a transceiver module 426 coupled to the radio processor 404. The transceiver module 426 may comprise one or more transceivers arranged to communicate using different types of protocols, communication ranges, operating power requirements, RF sub-bands, information types (e.g., voice or data), use scenarios, applications, and so forth. In various embodiments, the transceiver module 426 may comprise one or more transceivers arranged to support voice communications and/or data communications for the wireless network systems or protocols as previously described. In some embodiments, the transceiver module 426 may further comprise a Global Positioning System (GPS) transceiver to support position determination and/or location-based services.

The transceiver module 426 generally may be implemented using one or more chips as desired for a given implementation. Although the transceiver module 426 may be shown as being separate from and external to the radio processor 404 for purposes of illustration, it is worthy to note that in various embodiments some portion or the entire transceiver module 426 may be included on the same integrated circuit as the radio processor 404. The embodiments are not limited in this context.

The mobile computing device 400 may comprise an antenna system 428 for transmitting and/or receiving electrical signals. As shown, the antenna system 428 may be coupled to the radio processor 404 through the transceiver module 426. The antenna system 428 may comprise or be implemented as one or more internal antennas and/or external antennas.

The mobile computing device 400 may comprise a subscriber identity module (SIM) 430 coupled to the radio processor 404. The SIM 430 may comprise, for example, a removable or non-removable smart card arranged to encrypt voice and data transmissions and to store user-specific data for allowing a voice or data communications network to identify and authenticate the user. The SIM 430 also may store data such as personal settings specific to the user. In some embodiments, the SIM 430 may be implemented as an UMTS universal SIM (USIM) card or a CDMA removable user identity module (RUIM) card. The SIM 430 may comprise a SIM application toolkit (STK) 432 comprising a set of programmed commands for enabling the SIM 430 to perform various functions. In some cases, the STK 432 may be arranged to enable the SIM 430 to independently control various aspects of the mobile computing device 400.

As mentioned above, the host processor 402 may be arranged to provide processing or computing resources to the mobile computing device 400. For example, the host processor 402 may be responsible for executing various software programs including system programs such as operating system (OS) 434 and application programs 436. The OS 434 and the application programs 436 may be the same or similar to the application module 114 described with reference to FIG. 1. System programs generally may assist in the running of the mobile computing device 400 and may be directly responsible for controlling, integrating, and managing the individual hardware components of the computer system. The OS 434 may be implemented, for example, as a Palm OS®, Palm OS® Cobalt, Microsoft® Windows OS, Microsoft Windows® CE OS, Microsoft Pocket PC OS, Microsoft Mobile OS, Symbian OS™, Embedix OS, Linux OS, Binary Run-time Environment for Wireless (BREW) OS, JavaOS, a Wireless Application Protocol (WAP) OS, or other suitable OS in accordance with the described embodiments. The mobile computing device 400 may comprise other system programs such as device drivers, programming tools, utility programs, software libraries, application programming interfaces (APIs), and so forth.

Application programs 436 generally may allow a user to accomplish one or more specific tasks. In various implementations, the application programs 436 may provide one or more graphical user interfaces (GUIs) to communicate information between the mobile computing device 400 and a user. In some embodiments, application programs 436 may comprise upper layer programs running on top of the OS 434 of the host processor 402 that operate in conjunction with the functions and protocols of lower layers including, for example, a transport layer such as a Transmission Control Protocol (TCP) layer, a network layer such as an Internet Protocol (IP) layer, and a link layer such as a Point-to-Point (PPP) layer used to translate and format data for communication.

Examples of application programs 436 may include, without limitation, messaging applications, web browsing applications, personal information management (PIM) applications (e.g., contacts, calendar, scheduling, tasks), word processing applications, spreadsheet applications, database applications, media applications (e.g., video player, audio player, multimedia player, digital camera, video camera, media management), gaming applications, and so forth. Messaging applications may be arranged to communicate various types of messages in a variety of formats. Examples of messaging applications may include without limitation a cellular telephone application, a Voice over Internet Protocol (VoIP) application, a Push-to-Talk (PTT) application, a voicemail application, a facsimile application, a video teleconferencing application, an IM application, an e-mail application, an SMS application, an MMS application, and so forth. It is also to be appreciated that the mobile computing device 400 may implement other types of applications in accordance with the described embodiments.

The host processor 402 may include a resource management module 450. The resource management module 450 may the same or similar to the resource management module 105 described with reference to FIG. 1. Similarly, the radio processor 404 may include a resource detector 460. The resource detector 460 may be the same or similar to the resource detector 107 described with reference to FIG. 1.

The mobile computing device 400 may include various databases implemented in the memory 410. For example, the mobile computing device 400 may include a message content database 438, a message log database 440, a contacts database 442, a media database 444, a preferences database 446, and so forth. The message content database 438 may be arranged to store content and attachments (e.g., media objects) for various types of messages sent and received by one or more messaging applications. The message log 440 may be arranged to track various types of messages which are sent and received by one or more messaging applications. The contacts database 442 may be arranged to store contact records for individuals or entities specified by the user of the mobile computing device 400. The media database 444 may be arranged to store various types of media content such as image information, audio information, video information, and/or other data. The preferences database 446 may be arranged to store various settings such as rules and parameters for controlling the operation of the mobile computing device 400.

In some cases, various embodiments may be implemented as an article of manufacture. The article of manufacture may include a storage medium arranged to store logic and/or data for performing various operations of one or more embodiments. Examples of storage media may include, without limitation, those examples as previously described. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A mobile computing device, comprising:
a radio module;
a location detector operative to determine a location for the mobile computing device;
a processor to couple to the radio module and the resource database, the processor operative to execute a resource management module to access a resource profile having resource information for one or more cellular radiotelephone network resources accessible from the location, and control operations for a radio module based on the resource profile.

2. The mobile computing device of claim 1, the radio module comprising a resource detector operative to collect resource information for a current cell site or a neighbor cell site accessible from the location, the resource information comprising a cell site identifier, a received signal strength indication value, and a radio-frequency channel identifier for each cell site.

3. The mobile computing device of claim 1, comprising a resource database to couple to the processor, the resource database arranged to store the resource profile.

4. The mobile computing device of claim 1, the resource management module operative to access a resource database with the resource profile from a remote device using the radio module.

5. The mobile computing device of claim 1, the resource management module operative to send control directives to the radio module to control scanning operations for radio signals by the radio module in accordance with the resource information stored by the resource profile.

6. The mobile computing device of claim 1, the resource management module operative to send a control directive to the radio module to selectively scan for a radio-frequency channel for a cell site based on a radio-frequency channel identifier and a cell site identifier stored by the resource profile.

7. The mobile computing device of claim 1, the resource management module operative to send a control directive to the radio module to suspend scanning operations by the radio module when the resource information indicates there are no cellular radiotelephone network resources accessible from a location.

8. The mobile computing device of claim 1, the resource management module operative to send a control directive to the radio module to resume scanning operations by the radio module when the resource information indicates there are cellular radiotelephone network resources accessible from the location.

9. The mobile computing device of claim 1, the resource management module operative to send a control directive to the radio module to avoid a specific radio-frequency channel.

10. The mobile computing device of claim 1, the location detector operative to determine the location for the mobile computing device as a current location based on location information for the mobile computing device.

11. The mobile computing device of claim 1, the location detector operative to determine the location for the mobile computing device as a predicted location based on current location information, velocity information and direction information for the mobile computing device.

12. A method, comprising:
determining a location for a mobile computing device;
accessing a resource profile having resource information for one or more cellular radiotelephone network resources accessible from the location; and
controlling operations for a radio module based on the resource profile.

13. The method of claim 12, comprising accessing a resource database with the resource profile at the mobile computing device.

14. The method of claim 12, comprising accessing a resource database with the resource profile at a server with a radio module.

15. The method of claim 12, comprising storing resource information for a current cell site and a neighbor cell site accessible from the location as a resource profile in a resource database.

16. The method of claim 12, comprising controlling scanning operations for radio signals by the radio module in accordance with the resource information stored by the resource profile.

17. The method of claim 12, comprising scanning for a radio-frequency channel for a cell site based on a radio-frequency channel identifier and a cell site identifier stored by the resource profile.

18. The method of claim 12, comprising suspending scanning operations by the radio module when the resource information indicates there are no cellular radiotelephone network resources accessible from a location.

19. The method of claim 12, comprising resuming scanning operations by the radio when the resource information indicates there are cellular radiotelephone network resources accessible from the location.

20. The method of claim 12, comprising determining the location for the mobile computing device as a predicted location based on current location information, velocity information and direction information for the mobile computing device.

21. The method of claim 12, comprising switching from a first communication channel to a second communication channel based a resource profile corresponding to a predicted location for the mobile computing device.

22. The method of claim 12, comprising displaying a message for an operator of the mobile computing device based on resource information from a resource profile corresponding to a predicted location for the mobile computing device.

23. An article comprising a computer-readable storage medium containing instructions that if executed enable a system to:
determine a current location for a mobile computing device;
determine a velocity and direction for the mobile computing device;
generate a predicted location for the mobile computing device based on the velocity, the direction and the current location; and
access a resource profile having resource information for one or more cellular radiotelephone network resources accessible from the predicted location.

24. The article of claim 23, comprising instructions to control operations for a radio module based on the resource profile.

25. The article of claim 23, comprising instructions to control scanning operations for a radio module based on the resource profile.

26. The article of claim 23, comprising instructions to access a resource database with the resource profile at a server by the mobile computing device.
